(19) United States
(12) Patent Application Publication
(10) Pub. No.: US 2014/0019439 A1
(43) Pub. Date: Jan. 16, 2014

(54) SYSTEMS AND METHODS FOR PERFORMING SMART SEARCHES

(71) Applicant: salesforce.com, inc., San Francisco, CA (US)

(72) Inventors: Yurika Sebata-Dempster, San Francisco, CA (US); Luke Ball, Berkeley, CA (US); Susan Kimberlin, San Francisco, CA (US); Wallace Peng, San Francisco, CA (US); Yasaman Mohsenin, San Francisco, CA (US); Chelsey Glasson, San Francisco, CA (US)

(21) Appl. No.: 13/935,267

(22) Filed: Jul. 3, 2013

Related U.S. Application Data
(60) Provisional application No. 61/667,711, filed on Jul. 3, 2012.

(51) Int. Cl. G06F 17/30

(52) U.S. Cl. CPC G06F 17/30991
USPC 707/722

(57) ABSTRACT

A multi-tenant server system for executing search queries includes a database that stores multi-tenant data including data objects having associated data records for a plurality of users associated with a plurality of tenants, and a server system including a processor. The processor is configured to execute a method including the steps of applying search queries to the multi-tenant database and providing a search result set including a plurality of data objects each having at least one data record. The method further includes reordering the search result set according to predetermined scoping criteria based on individual user histories, including recency and frequency metrics, to produce a reordered search result set. The reordered set is filtered based on predetermined permission criteria associated with each user, and displayed.

### CROSS-REFERENCE TO RELATED APPLICATION

This application claims the benefit of U.S. provisional patent application Ser. No. 61/667,711, filed Jul. 3, 2012, which is hereby incorporated by reference in its entirety.

### TECHNICAL FIELD

Embodiments of the subject matter described herein relate generally to methods and systems for executing search queries in a multi-tenant environment. More particularly, embodiments of the subject matter relate to methods and systems for using user preferences and user history to modify search behavior, while controlling access to the search results based on user authorization levels.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system wherein a single hardware and software platform simultaneously supports multiple user groups (also referred to as “organizations” or “tenants”) from a common data store. The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, access can be granted or denied to specific sets of data for any user within the multi-tenant platform, thereby improving collaboration and integration between applications and the data managed by the various applications.

To increase accessibility of the data, multi-tenant architectures allow tenants to be able to perform robust queries on their data and to return search results without delay. At the same time, user access, security, permissions, and authorization level protocols impact the results which a particular user is allowed to view. Accordingly, it is desirable to provide methods and systems for streamlining the search process while leaving the user interface and user experience intact. Other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary multi-tenant data processing system having a query system in accordance with various embodiments;

FIG. 2 is a schematic layout diagram of a search flow in accordance with various embodiments;

FIG. 3 is a schematic layout diagram illustrating successively smaller sub-sets of data records retrieved from a data object during a search in accordance with various embodiments;

FIG. 4 is a screen shot showing a search query in accordance with various embodiments;

FIG. 5 is a screen shot showing the search results for the query in FIG. 4 presented to the user in accordance with various embodiments; and

FIG. 6 is a screen shot showing the “search all” and pinning in accordance with various embodiments.

### DETAILED DESCRIPTION

The following detailed description is merely exemplary in nature and is not intended to limit the disclosure the application and uses of the disclosure. Furthermore, there is no intention to be bound by any expressed or implied theory presented in the preceding technical field, background, brief summary or the following detailed description. It should be understood that throughout the drawings, corresponding reference numerals indicate like or corresponding parts and features.

The exemplary embodiments presented here relate to a smart searching paradigm based on user preferences and user history. The described subject matter can be implemented in the context of any computer-implemented system, such as a software-based system, a database system, a multi-tenant environment, or the like. Moreover, the described subject matter can be implemented in connection with two or more separate and distinct computer-implemented systems that cooperate and communicate with one another.

In accordance with exemplary embodiments described below, a computer based system is provided, such as a multi-tenant system, that is used to retrieve, sort, filter, and return search results to a unique one of a plurality of end users within a tenant organization based on that user's declared preferences, history, and permission (or authorization) level. Recognizing that people tend to dislike manually configuring their searches, the present disclosure describes various ways in which the system automatically configures (“scopes”) searches—on an individual by individual basis—based on each individual's viewing behavior and other tracked metrics. One of the key search scoping metrics involves identifying a sub-set of data objects in memory to be searched, based on the recency of the user's interaction with the available data objects. That is, those data objects which have not been interacted with for a predetermined period of time (e.g., 90 days) are not included in an initial search. The search engine thus redefines, over time, an individual's search scoping parameters based on prior search and viewing behavior for that user, as well as more traditional search filtering techniques.

In accordance with another embodiment, the “smart” search application of the present disclosure continually reconfigures the presentation order of the objects for which records are returned by the search based on a number of factors. More particularly, the order in which records rendered by the search are presented to the user may be based on the length of time since the user last interacted with the object containing records retrieved by the search (recency), and the frequency of interaction with a particular data object within a predetermined period of time. In addition, the present disclosure permits a user to manually prioritize the order in which search results are presented (referred to herein as pinning).

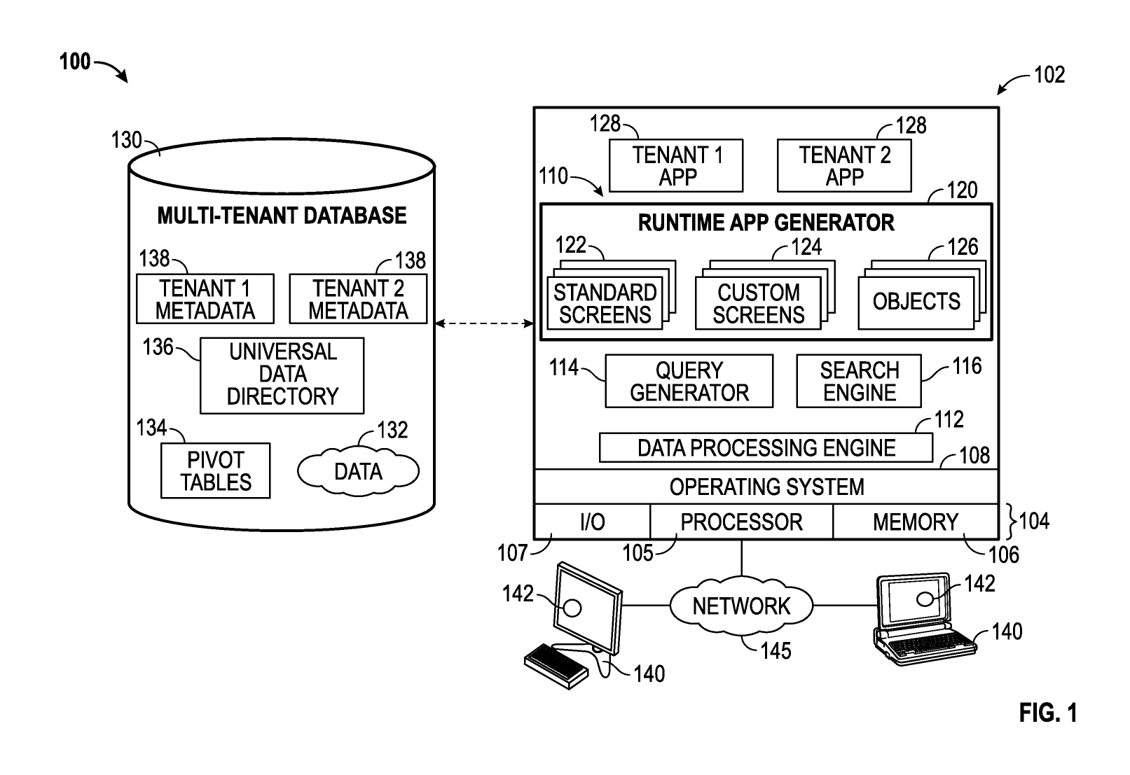

Turning now to FIG. 1, an exemplary multi-tenant application system 100 is shown to include a server 102 that is associated with a multi-tenant database 104. In accordance with various non-limiting examples, the system 100 may be implemented in the form of a multi-tenant customer relationship management system that can support any number of authenticated users of multiple tenants. A “tenant” or an “organization” generally refers to a group of users that shares access to common data 106 within the database 104. Tenants may represent customers, customer departments, business or legal organizations, and/or any other entities that maintain data for particular sets of users within the system 100. Although multiple tenants may share access to the server 102 and the database 104, the particular data and services provided from the server 102 to each tenant can be securely isolated from those provided to other tenants. The multi-tenant architecture therefore allows different sets of users to share functionality while managing the sharing of any or none of the data 106.

The server 102, as shown, generally includes any sort of conventional processing hardware 108, such as a processor 110, memory 112, input/output features 114 and the like, that are managed and accessed by a suitable operating system 116. The processor 110 may be implemented using one or more of microprocessors, microcontrollers, processing cores and/or other computing resources spread across any number of distributed or integrated systems, including any number of “cloud-based” or other virtual systems. The memory 112 represents any non-transitory short or long term storage capable of storing programming instructions for execution on the processor 110, including any sort of random access memory (RAM), read only memory (ROM), flash memory, magnetic or optical mass storage, and/or the like. The input/output features 114 represent conventional interfaces to networks (e.g., to a network 118, or any other local area, wide area or other network), mass storage, display devices, data entry devices and/or the like. As can be appreciated, the server 102 may be implemented using a cluster of actual and/or virtual servers operating in conjunction with each other, typically in association with conventional network communications, cluster management, load balancing and other features as appropriate.

The server 102 typically includes or cooperates with some type of computer-readable media, where a tangible computer-readable medium has computer-executable instructions stored thereon. The computer-executable instructions, when read and executed by the server 102, cause the server 102 to perform certain tasks, operations, functions, and processes described in more detail herein. In this regard, the memory 112 may represent one suitable implementation of such computer-readable media. Alternatively or additionally, the server 102 could receive and cooperate with computer-readable media (not separately shown) that is realized as a portable or mobile component or platform, e.g., a portable hard drive, a USB flash drive, an optical disc, or the like.

The server 102, as shown, further includes an application platform 120 that may be any sort of software application or other data processing engine that generates virtual applications 122 that provide data and/or services to user devices 124. The virtual applications 122 are typically generated at run-time in response to queries received from the user devices 124. The user devices 124 are typically operated by various tenants that subscribe to the system 100.

For the illustrated embodiment, the application platform 120 includes a bulk data processing engine 126, a query generator 128, a search engine 130 that provides text indexing and other search functionality, and a runtime application generator 132. Each of these features may be implemented as a separate process or other module, and many equivalent embodiments could include different and/or additional features, components or other modules as desired.

The data processing engine 126 performs bulk processing operations on the data 106 such as uploads or downloads, updates, online transaction processing, and/or the like that are requested by the query generator 128, the search engine 130, the virtual applications 122, etc. In various embodiments, less urgent bulk processing of the data 106 can be scheduled to occur as processing resources become available, thereby giving priority to more urgent data processing by the query generator 128, the search engine 130, the virtual applications 122, etc.

The runtime application generator 132 dynamically builds and executes the virtual applications 122 in response to specific requests received from the user devices 124. The virtual applications 122 created by or for the tenants are typically constructed in accordance with the tenant-specific metadata 134, which describes particular tables, reports, interfaces and/or other features of the particular application. In various embodiments, each virtual application 122 generates dynamic web content that can be served to a browser or other client program 136 associated with its user device 124, as appropriate. As used herein, such web content represents one type of resource, data, or information that may be protected or secured using various user authentication procedures.

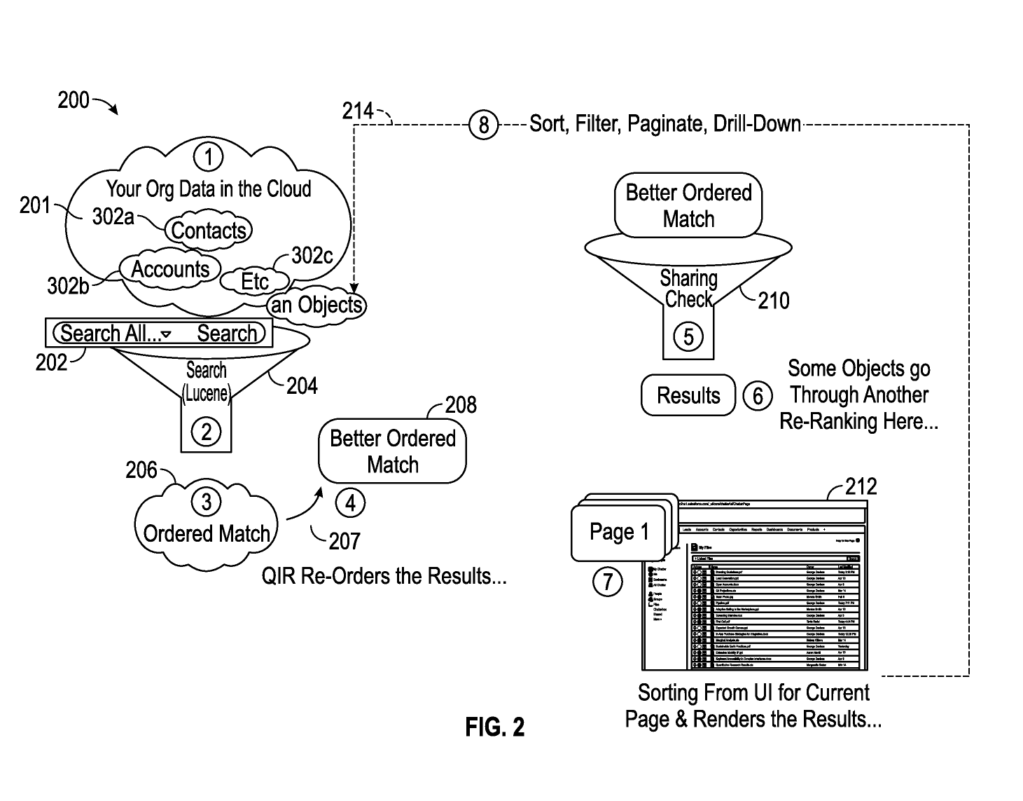

The runtime application generator 132 interacts with the query generator 128 to efficiently obtain multi-tenant data 106 from the database 104 as needed. In various embodiments, the query generator 128 considers the identity of the user requesting a particular function, and then builds and suggests queries to the user. The query generator 128 maintains security of the common database 104 by ensuring that queries are consistent with access privileges granted to a user that initiated the request. The query generator 128 suggests alternate queries based on the initial request while maintaining the security of the common database 104. In various embodiments, the query generator 128 and the processor 110 cooperate in an appropriate manner to perform and manage the various query generation methods described herein in more detail below with reference to FIGS. 2-7.

The database 104 is any sort of repository or other data storage system capable of storing and managing the data 106 associated with any number of tenants. The database 104 may be implemented using any type of conventional database server hardware. In various embodiments, the database 104 shares processing hardware 108 with the server 102. In other embodiments, the database 104 is implemented using separate physical and/or virtual database server hardware that communicates with the server 102 to perform the various functions described herein.

The data 106 may be organized and formatted in any manner to support the application platform 120. In various embodiments, the data 106 is suitably organized into a relatively small number of large data tables to maintain a semi-amorphous “heap”-type format. The data 106 can then be organized as needed for a particular virtual application 122. In various embodiments, conventional data relationships are established using any number of pivot tables 140 that establish indexing, uniqueness, relationships between entities, and/or other aspects of conventional database organization as desired.

Further data manipulation and report formatting is generally performed at run-time using a variety of metadata constructs. The system-wide metadata 138, for example, can be used to describe any number of forms, reports, workflows, user access privileges, business logic and other constructs that are common to multiple tenants. Tenant-specific formatting, functions and other constructs may be maintained as tenant-specific metadata 134 for each tenant, as desired. Rather than forcing the data 106 into an inflexible global structure that is common to all tenants and applications, the database 106 is organized to be relatively amorphous, with the pivot tables 140 and the metadata 134 providing additional structure on an as-needed basis. To that end, the application platform 120 suitably uses the pivot tables 140 and/or the metadata 134 to generate “virtual” components of the virtual applications 122 to logically obtain, process, and present the relatively amorphous data 106 from the database 104.

In operation, developers use the application platform 120 to create data-driven virtual applications 122 for the tenants that they support. Such virtual applications 122 may make use of interface features such as tenant-specific screens 142, universal screens 144 or the like. Any number of tenant-specific and/or universal objects 146 may also be available for integration into tenant-developed virtual applications 122. The data 106 associated with each virtual application 122 is provided to the database 104, as appropriate, and stored until it is requested or is otherwise needed, along with the metadata 134 that describes the particular features (e.g., reports, tables, functions, etc.) of that particular tenant-specific virtual application 122.

The data and services provided by the server 102 can be retrieved using any sort of personal computer, mobile telephone, portable device, tablet computer, or other network-enabled user device 124 that communicates via the network 118. Typically, the user operates a conventional browser or other client program 124 to contact the server 102 via the network 118 using, for example, the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 122, the runtime application generator 132 suitably creates the application at run time based upon the metadata 134, as appropriate.

The query generator 128 suitably obtains the requested data 106 from the database 104 as needed to populate the tables, reports or other features of the particular virtual application 122. As noted above, the virtual application 122 may contain Java, ActiveX, or other content that can be presented using conventional client software running on the user device 124; other embodiments may simply provide dynamic web or other content that can be presented and viewed by the user, as desired.

Turning now to FIG. 2, a flow diagram illustrates a search engine 200 (analogous to query generator 128) suitable for use in a computer-implemented server system such as the system 100 shown in FIG. 1. This generalized embodiment of the search engine 200 includes a query intake module 202 for interrogating a database 201, and an initial search rendering module 201 configured to yield an ordered set 206 responsive to the search request. As can be appreciated, the database 201 can be any data storage device or a combination of storage devices that may temporarily or permanently store data used by the query generator 200 and may be implemented on the server 102, on the database 104, and/or partly on the server 102 and partly on the database 104.

The search engine 200 further includes a first module 204 configured to return a first ordered set 206 of search results, a second module 207 for re-ordering the first set 206 into a second ordered set 208, and a filter 210 for checking sharing, access, and other permission and/or authorization levels to avoid presenting records to the user which the user is not authorized to view. The filter 210 outputs the final search results 212 for presentation to the user.

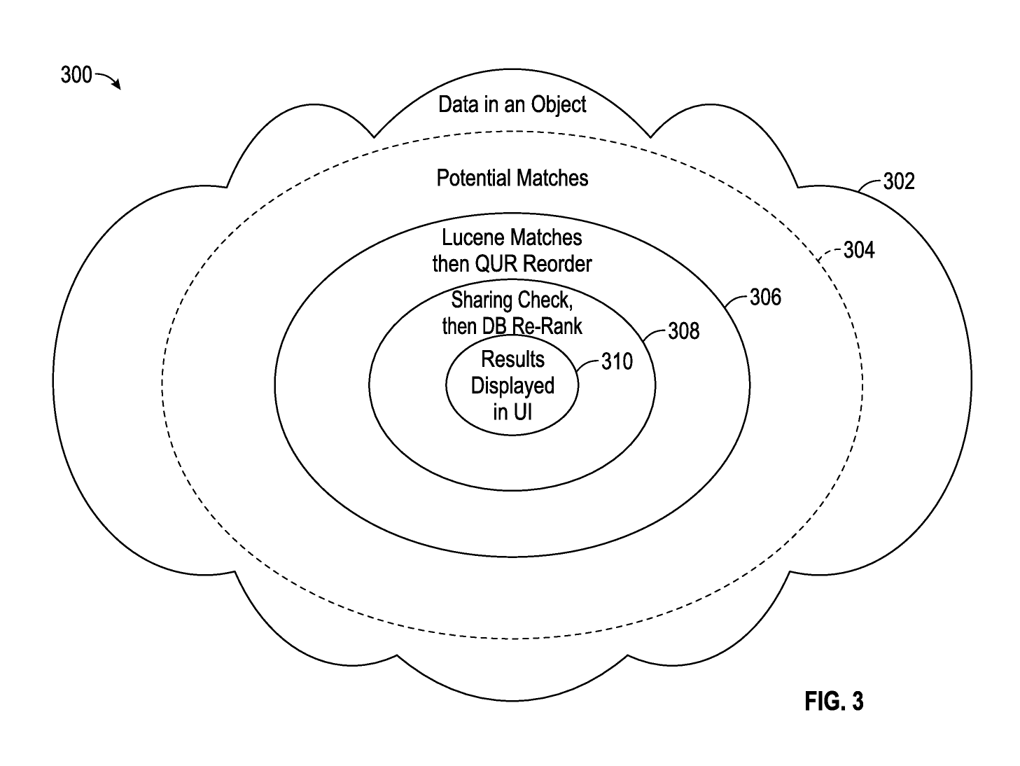

Referring now to FIGS. 2 and 3, a data map 300 includes a series of successively smaller rings representing corresponding subsets of the data records searched and ultimately presented to the user for a particular data object in accordance with the various embodiments implemented by search engine 200. More particularly, the data map 300 includes a data object 302 as it appears in the database 201, a sub-set 304 of records which satisfy a search query, a re-ordered set 306 corresponding to those records comprising sub-set 304 which also satisfy the criteria applied by the second module 207 (discussed below), a filtered set 308 which satisfy the criteria applied by the sharing check filter 210, and a final set 310 which is included in the final search results 212 displayed to the user.

With continued reference to FIGS. 2 and 3, the search engine 200 prompts the user to enter a search query into query module 202 displayed on a user interface such as, for example, by entering text using a keyboard or keypad associated with a desk top, lap top, or mobile computer. The search inquiry is then applied as an argument to that user's data objects stored in the database (cloud) 201. Each user within a tenant organization typically interacts with and stores a number of data objects 302a, 302b, 302c in the multi-tenant database, with each data object including a plurality of distinct data records. For example, a “contacts” data object may include an individual data record for each of the user's contacts, wherein each record includes one or more fields including the contact's name, address, telephone number, title, and the like. When a search query is applied to the database 201, the search engine 200 scopes the search such that one, all, or a sub-set of the user's data objects are searched, as described in greater detail below.

After applying the search query to the predetermined sub-set of data objects within database 201 (which may comprise all of a user's data objects), first module 204 returns the first ordered set 206 of search results, which generally corresponds to sub-set 304. The second module 207 re-orders each subset 304 within the first ordered set 206 to yield the second ordered set 208 which includes a re-ordered set 306 for each object within set 206. The re-ordered set 208 is then processed by the sharing check filter 210 to produce the final search results 212 which includes a final set 310 for each searched data object.

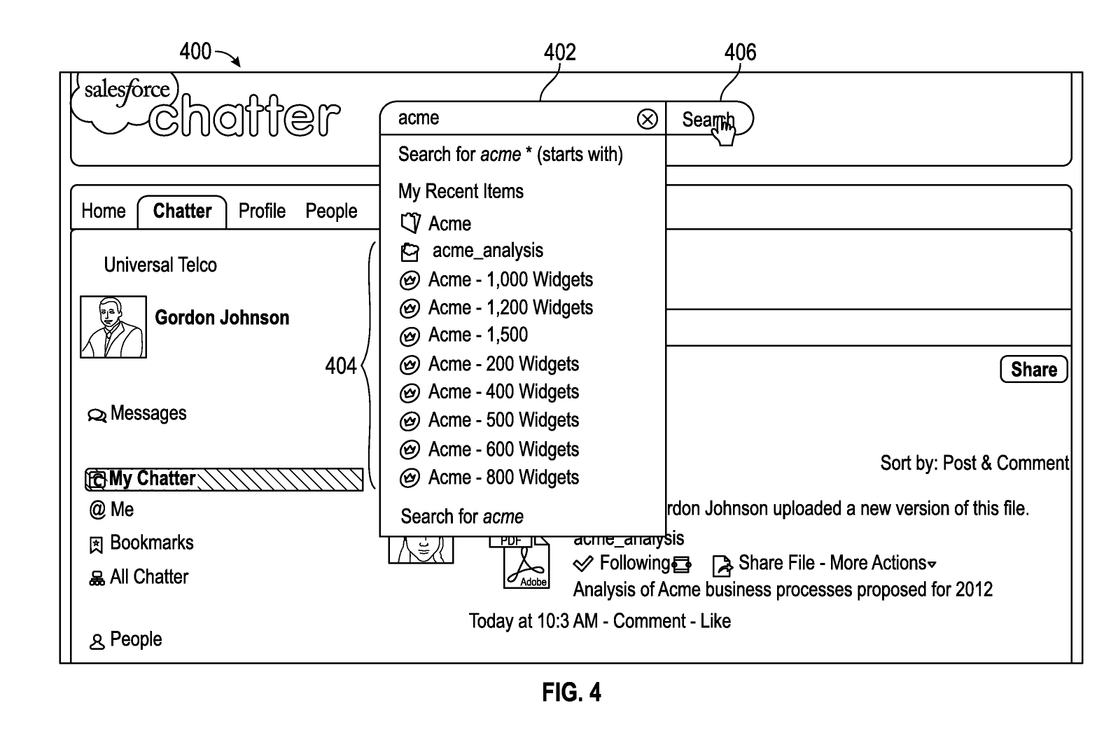

Referring now to FIG. 4, a screen shot 400 showing a search query module 402 (analogous to query intake module 202 of FIG. 2) is shown. Screen shot 400 further includes a pop-up 404 of recent searches to facilitate current searching. Once the precise form of the query is ascertained, the user clicks a search button 406 to commence searching, thereby initiating the flow described above in conjunction with FIG. 2.

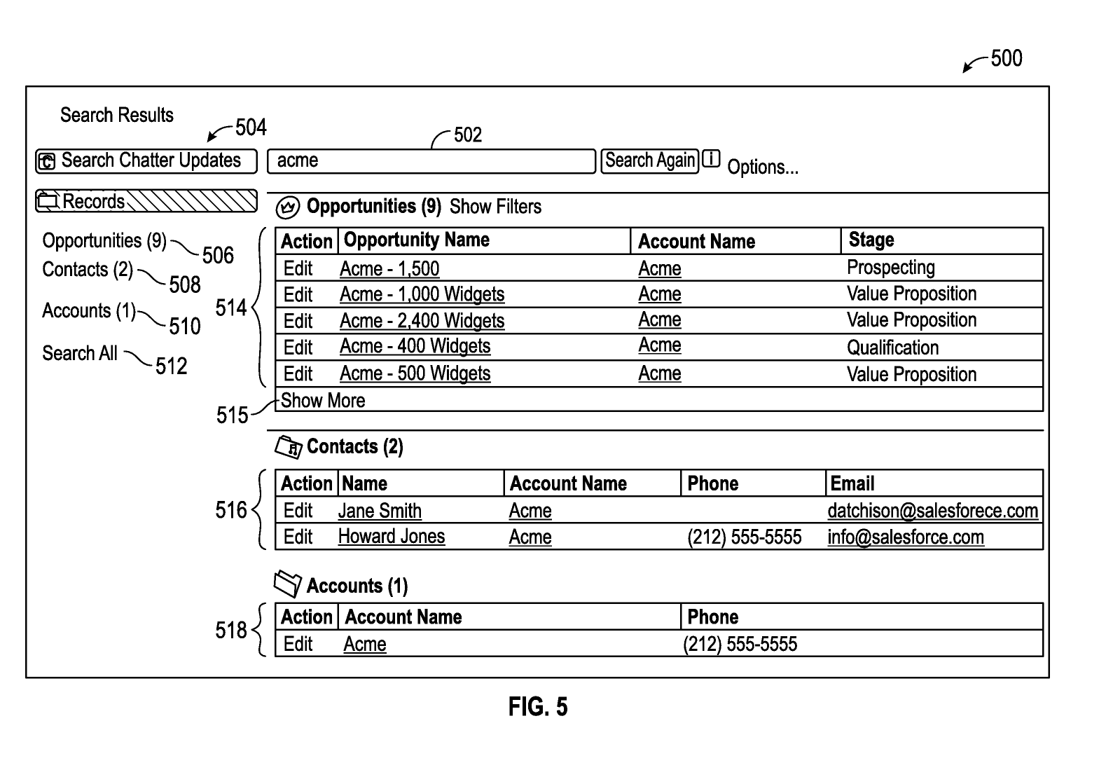

FIG. 5 is a screen shot 500 showing search results 504 corresponding to the query illustrated in FIG. 4 as they are presented to the user, where a query module 502 is analogous to the query module 402 of FIG. 4. More particularly, the search results 504 include three (3) objects which contain data records responsive to the search, namely: i) a first object 506 (“opportunities”) returning nine (9) records; ii) a second object 508 (“contacts”) returning two (2) records; and a third object 510 (“accounts”) returning one (1) record.

The screen shot 500 further includes a panel 514 showing a sub-set (e.g., the first five (5)) of the nine (9) records contained in object 506 in greater detail, a panel 516 showing both of the records contained in object 508, and a panel 518 showing the record contained in object 506. In addition, panel 514 includes a “show more” button 515 which, when actuated by the user, expands the panel 514 to reveal all of the records rendered by the search which belong to object 506.

Returning now to FIG. 2 and with continued reference to FIG. 5, in accordance with an embodiment, the objects contained in the search results 504 represent those objects which: i) are contained within the database 201; ii) satisfy the search query applied by query module 202, that is, the objects contained in the ordered set 206; iii) are contained within the re-ordered set 208 as a result of having satisfied the criteria applied by the second module 207; and iv) satisfy the criteria applied by the sharing check filter 210.

More particularly, the criteria applied by the second module 207 relate to the automatic search scoping metrics discussed above, and may include factors such as, for example, relevancy factors including key word associative relevancy, the number of records in each object, the length of time (e.g., 90 days) since the user last interacted with an object (recency), the number of times the user has interacted with the object within a pre-determined period of time and/or the number of times other users in the same tenant organization have interacted with the object (frequency), and the like.

The criteria applied by the sharing check filter 210 relate to permission levels, authorization, group membership, and other administrative protocols which determine which users are permitted access to the various objects and records contained within the database 201. Inasmuch as processing by the sharing check filter 210 is typically computationally expensive and time consuming, the present inventors have determined that reducing the number of records which must be processed by the filter 210 can effectively reduce total search and presentation cycle time. Hence, by automatically scoping the search to minimize the number of search results in accordance with the criteria applied by module 207, an appropriate balance may be achieved between processing time and search result relevancy.

With continued reference to FIGS. 2 and 5, the order (priority) in which objects are presented within the search results 504 may be based on any number of factors, including: i) the length of time (e.g., number of days) since the last interaction with any record in an object (recency); ii) the number of times any record(s) within an object was interacted with within a predetermined period of time, such as 90 days (frequency); and manual prioritization (e.g., pinning).

More particularly and by way of non-limiting example regarding the interplay between frequency and recency, suppose that a user interacted only one (1) record in data object A, and that interaction occurred 40 days ago. Suppose further that the user had three (3) record interactions within object B, and all three interactions occurred more than 40 days ago. Object B would present before (i.e., higher in priority and spatially above object B in search results 504) because, in an embodiment, frequency trumps recency; that is, the frequency rule has a higher priority than the recency rule.

In accordance with another embodiment, re-ordering module 207 will remove an object from the scoped search after 90 days, regardless of the frequency of interaction prior to 90 days. In this way, less relevant (that is, more remote in time) data objects need not be processed by the sharing check filter 210, resulting in more efficient searching. Similarly, data objects which are available to but not interacted with by a user, are filtered out (“scoped”) by the re-ordering module 207 until the object is interacted with at least a predetermined number of times (e.g., 1, 3, or the like).

In the context of the present disclosure, a data object is considered to be “interacted” with when it satisfies any desired predetermined and/or configurable interaction criteria. In one embodiment, a data object is interacted with when any record in it is opened; that is, the user “drills down” into the object by opening, clicking on, editing, revising, saving, or otherwise interacting with at least one data record within an object.

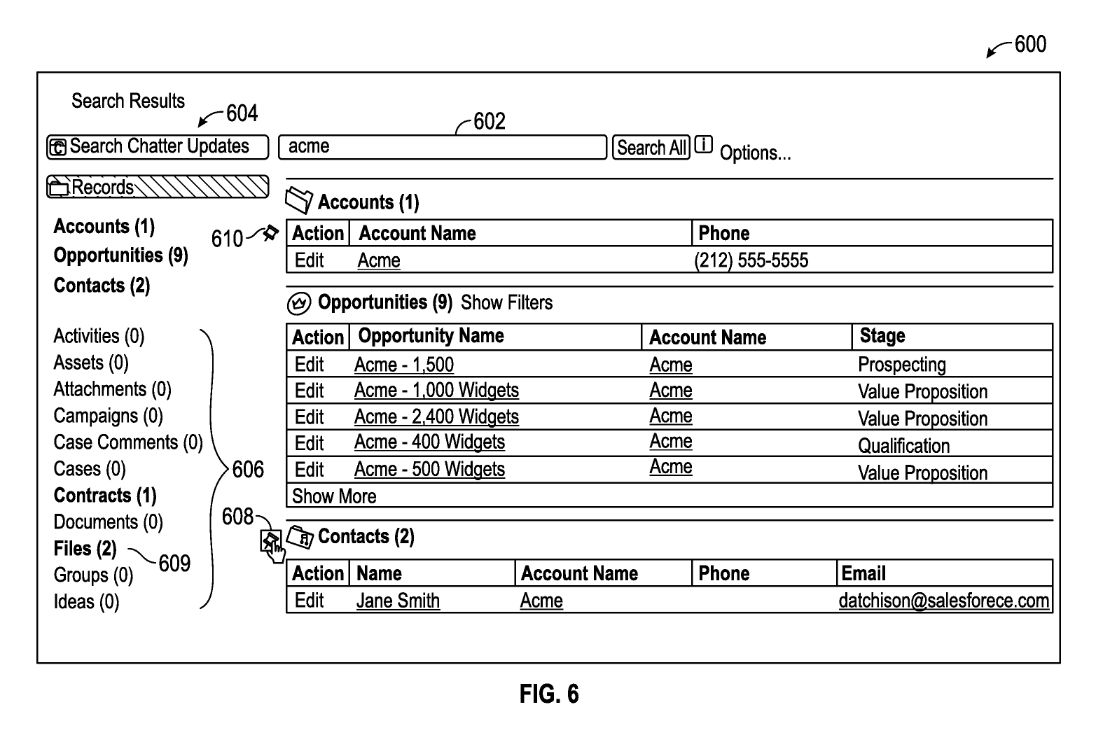

Turning now to FIG. 6, a screen shot 600 includes a query module 602, a search results section 604, an expanded search results panel 606, a pinning virtual button 608, and a pinned icon 610. More particularly, if a user is not satisfied with the automatically scoped search results 504 (see FIG. 5), the user may elect to effectively override some or all of the scoping metrics imposed by the scoping module 207 by clicking on the “search all” button 512, and thereby re-run the pending query on all data objects in database 201. By doing so, the search is re-executed on all data objects within database 201, resulting in the expanded search results panel 606. The expanded search results panel 606 may or may not include additional records, depending on whether otherwise relevant records were filtered out by module 207 in the initial scoped search.

With continued reference to FIG. 6, a user may manually reconfigure the scoping metrics utilized by scoping module 207, as well as the order of presentation of the search results, by clicking on (or otherwise actuating) the pinning button 608. In particular, in one embodiment the user may right click on an object within the initial results 604 or the expanded results 606, to reveal an associated pinning button 608. By clicking on pinning button 608, the corresponding object (e.g., the “files” object 609 in FIG. 6) may be “pinned”; that is, the object is placed at the top of the search results section 604. As such, in an embodiment, the pinned object becomes part of the scoped objects and will not be filtered out by scoping module 207, at least for as long as it remains “recent” (e.g. for 90 days from the time of pinning).

In accordance with another embodiment, if no data objects have been interacted with within the defined period of recency, i.e., no data objects have been interacted with for at least 90 days (such as, for example, when a new user joins an organization), smart searching engine may default to searching all data objects having records which satisfy the then current query. Thereafter, as the user interacts with various data objects, the scoping module 207 may re-order the search results in accordance with the dynamically reconfigured scoping metrics based on user behavior (i.e., interaction with data objects).

Moreover, the system may delay implementation of the “smart search” learning engine for some users until sufficient usage data is acquired to facilitate initial search scoping. In one embodiment, the system may collect usage data for a period of time (e.g., several days, weeks, or months) or, alternatively, accumulate a predetermined threshold number of interactions for one or more objects, such as, for example, three to one hundred (e.g., twenty) total interactions.

In the embodiments discussed above, the smart search engine is implemented in the context of a multi-tenant environment. Those skilled in the art will appreciate, however, that the structures, methods, and techniques described herein may also be implemented outside the multi-tenant environment, for example, if an organization employs a sharing filter to discriminate among users with different permission and security levels. Indeed, even if all users within an organization share the same permissions, the smart search engine described herein still has value in reducing the computational complexity of searches and in and streamlining the presentation of search results.

A computer-implemented method executable by a multi-tenant server system for executing search queries is thus provided. The method includes: providing, by a user, a search query to a query module; applying the search query to a multi-tenant database having a plurality of data objects, each having at least one associated data record; providing, responsive to applying, an initial search result set including at least a first data record associated with at least a first data object; reordering the initial search result set according to predetermined scoping criteria to produce a reordered search result set; filtering the reordered search result set based on predetermined sharing criteria associated with the user; and displaying the filtered reordered search result set.

In various embodiments, the scoping criteria may include a recency component which relates to determining whether the user interacted with the first data object within a predetermined period of time in the range of 1 to 180 days, and preferably about 90 days. The scoping criteria may also include a frequency component which relates to determining the number of times the user interacted with the first data object within a predetermined period of time, wherein the number of times the user interacted with the first data object is in the range of 1 to 10, and preferably about 3.

In another embodiment, the scoping criteria relates to interaction by the user i with the first data object, and wherein interaction comprises viewing a data record within the first data object. Alternatively, the interaction comprises opening a data record within the first data object.

In another embodiment, displaying may include displaying a “search all” option, such that selecting the search all option at least partially overrides the reordering step. For example, selecting search all may override a primary criterion and a recency criterion associated with the reordering.

In a further embodiment, displaying the filtered reordered search result set comprises presenting a plurality of data objects, each displaying an integer number of data records associated therewith, respectively, in a predetermined order based on recency and frequency criteria.

In another embodiment, the method further includes pinning one of the plurality of data objects to thereby reprioritize the predetermined order of display in subsequent searches.

In yet another embodiment, applying comprises applying the search query to a sub-set of the user's data objects stored in the multi-tenant database, wherein the sub-set may be based on recency and/or frequency metrics.

In yet a further embodiment, applying comprises applying the search query to all of the user's data objects stored in the multi-tenant database.

A computer program product is also provided for performing scoped searches. The program product may include a tangible storage medium readable by a processor and configured to store instructions for execution by the processor for performing a method comprising: applying a search query to a multi-tenant database having a plurality of data objects associated with a user, each data object having at least one data record; providing a search result set including a first data record associated with a first data object; reordering the search result set according to predetermined scoping criteria, including recency and frequency metrics, to produce a reordered search result set; filtering the reordered search result set based on predetermined permission criteria associated with the user; and displaying the filtered reordered search result set.

A multi-tenant server system is also provided for executing search queries, the system including a database that stores multi-tenant data including data objects having associated data records for a plurality of respective users associated with a plurality of tenants, and a server system including a processor configured to: apply search queries to the multi-tenant database; provide a search result set including a plurality of data objects each having at least one data record; reorder the search result set according to predetermined scoping criteria based on individual user histories, including recency and frequency metrics, to produce a reordered search result set; filter the reordered search result set based on predetermined permission criteria associated with each user; and display the filtered reordered search result set

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method executable by a multi-tenant server system for executing search queries, the method comprising:
providing, by a user, a search query to a query module;
applying the search query to a multi-tenant database having a plurality of data objects, each having at least one associated data record;
providing, responsive to applying, an initial search result set including at least a first data record associated with at least a first data object;
reordering the initial search result set according to predetermined scoping criteria to produce a reordered search result set;
filtering the reordered search result set based on predetermined sharing criteria associated with the user; and
displaying the filtered reordered search result set.

2. The method of claim 1, wherein the scoping criteria include a recency component.

3. The method of claim 2, wherein the recency component comprises determining whether the user interacted with the first data object within a predetermined period of time.

4. The method of claim 3, wherein the predetermined period of time is in the range of 1 to 180 days.

5. The method of claim 4, wherein the predetermined period of time is about 90 days.

6. The method of claim 1, wherein the scoping criteria include a frequency component.

7. The method of claim 6, wherein the frequency component comprises determining the number of times the user interacted with the first data object within a predetermined period of time.

8. The method of claim 7, wherein the number of times the user interacted with the first data object is in the range of 1 to 10.

9. The method of claim 8, wherein the number of times is about 3.

10. The method of claim 1, wherein the scoping criteria relate to the user interaction with the first data object, and wherein interaction comprises viewing a data record within the first data object.

11. The method of claim 1, wherein the scoping criteria relate to the user interaction with the first data object, and wherein interaction comprises opening a data record within the first data object.

12. The method of claim 1, wherein displaying further comprises displaying a search all option, the method further comprising selecting the search all option to thereby at least partially override the reordering.

13. The method of claim 12, wherein selecting search all overrides a primary criterion and a recency criterion associated with the reordering.

14. The method of claim 1, wherein displaying the filtered reordered search result set comprises presenting a plurality of data objects, each displaying an integer number of data records associated therewith, respectively, in a predetermined order based on recency and frequency criteria.

15. The method of claim 14, further comprising pinning one of the plurality of data objects to thereby reprioritize the predetermined order of display in subsequent searches.

16. The method of claim 1, wherein applying comprises applying the search query to a sub-set of the user's data objects stored in the multi-tenant database.

17. The method of claim 16, wherein the sub-set is based on at least one of recency and frequency.

18. The method of claim 1, wherein applying comprises applying the search query to all of the user's data objects stored in the multi-tenant database

19. A computer program product for performing scoped searches, comprising a tangible storage medium readable by a processor and configured to store instructions for execution by the processor for performing a method comprising:
applying a search query to a multi-tenant database having a plurality of data objects associated with a user, each data object having at least one data record;
providing a search result set including a first data record associated with a first data object;
reordering the search result set according to predetermined scoping criteria, including recency and frequency metrics, to produce a reordered search result set;
filtering the reordered search result set based on predetermined permission criteria associated with the user; and
displaying the filtered reordered search result set.

20. A multi-tenant server system for executing search queries, comprising:
a database that stores multi-tenant data including data objects having associated data records for a plurality of respective users associated with a plurality of tenants; and
a server system including a processor configured to:
apply search queries to the multi-tenant database;
provide a search result set including a plurality of data objects each having at least one data record;
reorder the search result set according to predetermined scoping criteria based on individual user histories, including recency and frequency metrics, to produce a reordered search result set;
filter the reordered search result set based on predetermined permission criteria associated with each user; and
display the filtered reordered search result set.
